(19) United States
(12) Patent Application Publication
(10) Pub. No.: US 2002/0068589 A1
(43) Pub. Date: Jun. 6, 2002

(54) METHOD OF SENDING A DATA SET TO A RADIOTELEPHONE TERMINAL IN COMMUNICATION, AND CORRESPONDING TERMINALS

(76) Inventors: RONAN GABOU, PARIS (FR); FREDERIC RAOULT, SHANGHAI (CN)

Correspondence Address: SUGHRUE MION ZINN MACPEAK & SEAS PLLC, 2100 PENNSYLVANIA AVENUE NW, SUITE 800, WASHINGTON, DC, 200373213

(21) Appl. No.: 09/323,122

(22) Filed: Jun. 1, 1999

(30) Foreign Application Priority Data
Jun. 8, 1998 (FR) 98 07 163

(51) Int. Cl. H04M 11/10; H04M 3/00; H04Q 7/20

(52) U.S. Cl. 455/466; 455/419; 455/412

(57) ABSTRACT

A method of sending a data set, in particular a directory data set, to the portable terminal of a user of a cellular radiotelephone network, and in particular a GSM-type network, from another terminal of the network, during a radiotelephone call that is in progress. The method makes provision for triggering a transmission stage, on the initiative of said other terminal, in which the data for transmission from a data set is transmitted via a service channel of the radio channel used by said other terminal for the call that is in progress. The terminals includes means that can be actuated at will for the purpose of extracting a stored data set and of transmitting it, as well as for the purpose of storing it on reception.

The present invention relates to a method designed to enable a data set to be sent to the portable terminal of a user of a cellular radiotelephone network from another terminal, while a call is in progress, and in particular when the network is of the GSM type. The invention also relates to terminals making it possible to implement the method.

### BACKGROUND OF THE INVENTION

The portable terminals of users of cellular radiotelephone networks conventionally include storage means for temporarily or permanently storing data which makes it possible to keep data sets, and in particular directory data sets, for the benefit of users. It is often necessary to update the data sets that are kept, in particular by adding and/or replacing data. Such updating may be initiated by a user who wishes to add new data to be kept and/or to refresh data that has become obsolete. It may also be initiated by a radiotelephone service provider, e.g. by the operator of the radiotelephone network to which a user has access via a determined terminal.

As is known, the storage means with which a portable terminal of a radio-mobile network is provided generally comprises a memory allocation reserved for the user in a modifiable memory, usually a RAM-type memory. Another memory allocation is also reserved for each user in a modifiable memory of the subscriber identity module or card (SIM) that the user must insert into a terminal to enable the terminal to be used. A user may therefore usually store data, and more particularly identity data sets relating to other users, in a directory situated in the modifiable memory of a terminal used by the user, as well as in a directory situated in the subscriber identity card of the user.

Furthermore, a service provider may also wish to update data sets that is stored in the terminals of users who use its services, when such data is stored in the modifiable memories of a terminal or of a subscriber identity card.

Updating a directory of data in a modifiable memory of the portable terminal of a user of a network is an operation which is generally considered as a chore by those users who bother to do it, even if it is ultimately beneficial. It is therefore important for it to be simple and quick to perform, and for the risk of mistakes to be as low as possible.

In particular, this is not the case when the user has the portable terminal only, and when the user must enter data required for updating by using control means, and in particular a keypad with which the portable terminal is conventionally equipped.

In the absence of a special arrangement, a user in communication with another user by radio-telephone must read, out loud and into the microphone of the terminal being used, the data that the user wishes to send, and that is stored in a directory in the user's portable terminal. The data picked up by the microphone is then transmitted by radio to the portable terminal of the other user in the form of a digitized sound message. It must then be reconverted into sound form at the receive terminal, so as to be heard by the destination user who must find means for keeping the data, e.g. in handwritten form, or in the form of a sound recording. The data that has just been sent to the destination user who wishes to store it must then be entered into the directory of the destination user's terminal or subscriber identity card.

### OBJECTS AND SUMMARY OF THE INVENTION

The invention provides a method of sending a data set, in particular a directory set, to the portable terminal of a user of a cellular radiotelephone network, and in particular a GSM-type network, from another terminal of the network, during a radiotelephone call that is in progress.

According to a characteristic of the invention, the method makes provision to implement a transmission stage, on the initiative of said other terminal, in which the stored data for transmission from a data set is transmitted via a service channel of the radio channel used by said other terminal for the call that is in progress.

The invention also provides a terminal for a cellular radiotelephone network, and in particular for a GSM network, for implementing the above-mentioned method.

According to a characteristic of the invention, said terminal includes means that can be actuated at will for the purpose of extracting a stored data set, in particular in modular form, in a modifiable memory with which it is provided, and control means organized to send the data set via a service channel of the radio channel used to communicate with another terminal, while a call is in progress with said other terminal.

According to another characteristic of the invention, the terminal also includes control means organized to enable it to store, at least temporarily, and in a modifiable memory with which it is provided, a data set that has been sent to it from another terminal during a call set up with said terminal, the data being sent via the service channel used by said other terminal.

### BRIEF DESCRIPTION OF THE DRAWING

The invention, its characteristics, and its advantages are made clearer in the following description given with reference to the below-listed figures, in which:

FIG. 1 is a diagram summarizing a radiotelephone network; and

FIG. 2 is a block diagram summarizing the portable terminal of a user of a radiotelephone network.

### MORE DETAILED DESCRIPTION

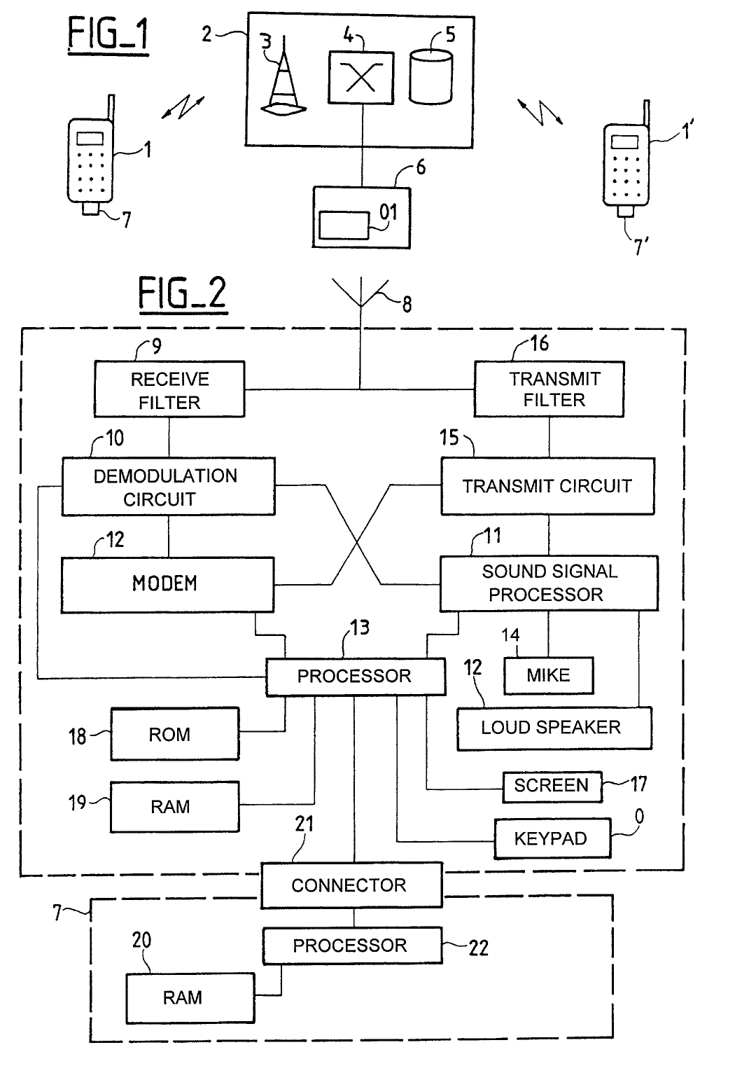

The radiotelephone network summary diagram shown in FIG. 1 relates to a radiotelephone network in which a plurality of users equipped with user portable terminals represented by two such terminals referenced 1 and 1′ can communicate by radiotelephone via equipment of a network 2.

For example, the network 2 may be a network of a global system for mobile communications (GSM), and it includes at least one transmission base station 3 making it possible to communicate by radio with the portable terminals 1, 1′, this station being represented in this example by an antenna tower.

The transmission base stations are geographically scattered, they are connected together via a transmission and switching network 4 which enables them to be interconnected selectively. This is used to set up calls between portable terminals, when they are served by different base stations within range of which they are respectively situated.

A control assembly 5 including, in particular, data bases relating to the users, and suitable data-processing means, makes it possible to manage calls between users. The control assembly 5 is supervised by one or more operators including, in particular, a main network operator, and optionally service operators, the operators being provided with intervention means 6 for the purpose of supervising the control assembly. The intervention means make it possible in particular to transmit data to the elements making up the network 2 and to the portable terminals 1, 1′. The portable terminals are accessible from specialized terminals that are usually stationary, and that are represented in this example by a terminal 01.

As is known, the users must have means enabling them to identify themselves, which means are constituted by subscriber identity modules (SIMs) which are, for example, of the SIM card type, such as the cards 7 and 7′, and which are associated by the users with the respective terminals that they wish to use. As is known, the identity data specific to a SIM card inserted in a terminal is sent to the base station with which the terminal locates itself when it is switched on. Each portable terminal also includes an identity that it can send by radio to a base station with which it locates itself.

It is briefly recalled, with reference to FIG. 2, that a portable terminal 1 is assumed to a radio transmitter-receiver for transmitting and receiving digital or digitized signals. Such a terminal therefore comprises a voice-data signal transmit-receive interface, a control unit incorporating at least one processor and various memories, and a man-machine interface.

The transmit-receive interface which is conventionally connected to an antenna 8 organized to pick up a radio signal associating a radiotelephone signal with control signals. A receive filter 9 makes it possible to extract the received radio-telephone signal in order to apply it to a demodulation circuit 10. The demodulation circuit is connected to a modem 12 and to a processing circuit 11 for performing telephone signal processing or “sound signal processing”. The processing circuit 11 is connected to a sound signal play-back unit represented in this example by a loudspeaker 12, and it is also connected to a processor 13 of the control unit of the terminal 1 for the purpose of transmitting any telephone-type signaling conveyed in the received radiotelephone signal. The processing circuit 11 and the modem 12 are used both for transmission and for reception, under the control of the processor 13 with which they are in communication.

The processing circuit 11 is therefore connected to a signal transducer unit represented in this example by a microphone 14 so as to take into account the sound signals received by the terminal, and more particularly produced by the user. It also processes any telephone-type signaling such as dual tone multi-frequency (DTMF) signaling that is applied to it by the control unit of the terminal, via the processor 13 in this example. Such signaling is produced in particular on the instigation of the user, during certain operating stages, e.g. by acting on control means on the terminal and represented in this example by a control keypad 0. The signals taken into account for transmission purposes by the processing circuit 11 are applied to a transmission circuit 15 assigned, in particular, to modulating them. The same applies for any data signals that are applied by the modem on the initiative of the user or of the control unit of the terminal 1. The transmission circuit 15 is connected to the antenna 8 via a transmit filter 16 assigned to removing signal components other than those which are part of the transmit channel via which the terminal communicates with the network 2.

The data received by the terminal and taken into account, either via the processing circuit 11 or via the modem 12, is, in this example, assumed to be applied to the control unit of the terminal, via the processor 13 which directs it for the purpose of using it. The displayable data is assumed to be suitable for being applied to a display screen 17 so that it can be presented to the user.

Writable and preferably modifiable memories also make it possible to store data whose subsequent use is possible or planned. Data, in particular program data, is stored permanently, in particular, for the benefit of the processor 13, and for example in a memory 18 of the ROM type.

Modifiable data storage memories 19 and 20 are assumed to be located firstly in the terminal, and secondly on subscriber identity cards 7, 7′. The memory 20 on a card is accessible via a releasable connector 21 by means of which the card is connected to the control unit of the terminal, i.e. to the processor 13, in this example, and via an access control processor 22 of the card.

As indicated above in the introduction of the present specification, provision is conventionally made to store data in the modifiable memories, such as 19 and 20, which can be used in a portable user terminal 1 or 1′ equipped with a subscriber identity card 7 or 7′.

Such data may be more particularly intended for the user, and it may be entered for this purpose either by the user or by a service provider using a suitable terminal 01.

Such data is often assembled in sets of identical or similar structure and stored in modular form to make it easier for the data to be used by the user. Such sets may, for example, be distinct sets of the same directory, in particular a directory of radiotelephone call numbers. A set may contain set identity data that is in modular form, and that is conventionally the name of an individual or of a company. This data is commonly accompanied by at least one other reference module which corresponds, for example, to a radiotelephone call number, a facsimile number, or an address, etc.

A user may wish to send a data set stored by the user to another user during a call. A radiotelephone service provider may also wish to send one or more data sets to the subscribers of a radiotelephone network. This may, in particular, occur for updating, e.g. performed when an active user terminal locates itself with a base station.

In the invention, a transmission stage is launched by the user of a terminal, such as 1 or 01, that has to send a set of one or more modules that it stores to another terminal, such as 1′, with which it is in communication via the radiotelephone network 2. The transmission takes place via a service channel of the radio channel that the terminal 1 or 01 is using to communicate in the call which is then in progress with the destination terminal 1′.

The service channel is, for example, the signaling channel provided in the radio channel used by the terminal 1 to communicate with the terminal 1′.

The service channel is, for example, a short message service (SMS) channel available to the terminal 01 of a service provider in a call that it has set up with the destination terminal under the conditions mentioned above. The data set may be split up prior to transmission if the format acceptable to the service channel used so requires. The set is then reconstructed by the control unit of the destination terminal.

Extracting a stored data set to be transmitted is triggered prior to transmission by the sender user, it being necessary for the data to be transmitted during a call stage in which the sender is in communication with the destination user. Optionally, a plurality of sets may be extracted in this way. Such extraction is, for example, caused by selective control effected via the keypad 0 of the terminal in which the data sets are stored. Extraction consists in reading that portion of the modifiable memory of the sender terminal in which the data to be transmitted is stored. This portion of memory may belong to either of the modifiable memories 19 or 20 available to the user in the portable terminal used by said user. The data corresponding to the data to be transmitted is then sent to the modem 12 via the control unit of the terminal and optionally after formatting. The modem then transmits the duly modulated data to the transmission circuit 15 which transmits it by radio in the service channel of the radio channel which is used for transmission by the sender terminal. The initiative to send such data from one terminal to another may naturally be taken by either of the two users in communication.

The portable terminal that receives the data relating to a data set by radiotelephone in this way, preferably demodulates it by means of the modem 12 with which it is provided. It applies said data for the purpose of storing it at least temporarily to the modifiable memory 19 associated with the processor 13 of the control unit with which it is provided. The data set is preferably displayed on the screen 17 of the terminal so as to enable the destination user to monitor the data that said destination user has received. Such storage makes it possible for the destination user to use directly at least one module contained in a set if the destination user needs to immediately, e.g. for calling another terminal whose call number has just been sent to said destination user. It is also possible for a data set to be stored permanently in either of the modifiable memories 19 and 20 available to the destination terminal when it is equipped with an identity card 7. Such storage is performed, for example, by the destination user entering a command on the keypad 0 of the terminal available to said destination user, in a manner corresponding to the manner that enables the destination user to enter data relating to a data module into said terminal, outside of call stages.

The method of the invention may be implemented from a sender terminal 00 of a service provider (usually a stationary non-radiotelephone terminal) under similar conditions when the destination terminal is in communication with a transmission base station 3 of the radiotelephone network. The method is preferably implemented via the short message service (SMS) channel to which the terminal 00 has access via an access point of the switching network 4 which serves the transmission base station 3 with which the destination terminal located has located itself. The data set is used by the destination terminal under almost the same conditions as above, once the data received by radio has been demodulated and extracted from the SMS channel that served to convey it, and these conditions are not therefore re-described below. It should be understood that the terminals involved in such calls include means, in particular of the control software type, which are used in their respective control units for applying the method of the invention. These means are not described in detail herein insofar as they can be implemented by applying techniques well known to the person skilled in the art.

1. A method of sending a data set, in particular a directory data set, to the portable terminal of a user of a cellular radiotelephone network, and in particular a GSM-type network, from another terminal of the network, during a radiotelephone call that is in progress, said method comprising implementing a transmission stage, on the initiative of said other terminal, in which the stored data for transmission from a data set is transmitted via a service channel of the radio channel used by said other terminal for the call that is in progress.

2. A method according to claim 1, in which the data of a data set is stored in the form of individualized modules, is transmitted in a format corresponding the format in application on the service channel that is used, the set then being reconstructed after reception so as to be displayed and/or used immediately and/or subsequently by the receive terminal.

3. A method according to claim 1, in which provision is made to store, at least temporarily, the data set received by a terminal, when data is sent via the service channel used by said other terminal with which it is in communication.

4. A method according to claim 1, in which the service channel used is the SMS channel provided for the purpose of sending short service messages from said other terminal.

5. A method according to claim 1, in which the service channel used is the signaling channel of the radio channel used by said other terminal.

6. A method according to claim 4, in which the stored data set that is sent comes from a terminal of a service provider of the radio-mobile telephone.

7. A method according to claim 5, in which the stored data set that is sent is extracted from a modifiable memory of a user portable terminal.

8. A terminal for a cellular radiotelephone network, and in particular for a GSM network, for implementing the method according to claim 1, said terminal including means that can be actuated at will for the purpose of extracting a stored data set, in particular in modular form, from a modifiable memory with which it is provided, and control means organized to send the data set via a service channel of the radio channel used to communicate with another terminal, while a call is in progress with said other terminal.

9. A user portable terminal according to claim 8, including control means organized to enable it to store, at least temporarily, and in a modifiable memory with which it is provided, a data set that has been sent to it from another terminal during a call set up with said terminal, the data being sent via the service channel used by said other terminal.
